(19) United States
(12) Patent Application Publication
(10) Pub. No.: US 2007/0102360 A1
(43) Pub. Date: May 10, 2007

(54) POLYMER BLENDING SYSTEM

(76) Inventor: Joseph W. Dendel, Allegan, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/553,065

(22) Filed: Oct. 26, 2006

Related U.S. Application Data
(60) Provisional application No. 60/731,031, filed on Oct. 28, 2005.

(51) Int. Cl. B01D 11/00

(52) U.S. Cl. 210/639; 422/256; 210/511; 366/150.1

(57) ABSTRACT

A system for extracting liquid from a mass comprising a system mass input, a blending system connected to the system mass input, with the blending system being configured to mix a polymer with a fluid to form a mixed solution, a liquid extraction assembly connected to the blending system, and piping having a first section between the system mass input and the blending system and a second section between the blending system and the liquid extraction assembly. The system is configured to have mass inputted into the system mass input, transport the mass to the blending system through the first section of the piping, inject the mixed solution into the mass in the blending system, and transport the mass from the blending system to the liquid extraction assembly. The blending system comprises a mechanically movable assembly for mixing the polymer with the fluid.

### CROSS-REFERENCE TO RELATED APPLICATION

This application claims priority to U.S. Provisional Patent Application No. 60/731,031 filed on Oct. 28, 2005 entitled POLYMER BLENDING SYSTEM.

### FIELD OF THE INVENTION

The present invention concerns blending of two or more liquids into one homogenously liquid stream, and more particularly relates to a polymer blending and surfactant washing system, particularly in use for adding flocculants and coagulants in a liquid/solid extraction system prior to filtration.

### BACKGROUND OF THE INVENTION

Apparatus for filtering, compressing, liquid extraction, washing and chemical treatment of sludge, slurries or other wet materials are well known. Such equipment finds particular application in the pulp and paper industry, waste water treatment, mineral processing, agriculture, food processing, pharmaceutical manufacturing, fisheries, breweries, wineries, chemical processing, oil and tar sands industry, etc. The systems typically use a chemical (e.g., polymer) blending system for adding a mixture of polymer, coagulant and dilution water to the sludge, slurries or other liquid/solid materials. The systems typically employ several components (e.g., aging tanks) to accomplish a desired blending of the chemicals (e.g., polymers and coagulants used in filtration and liquid/solid separation systems).

An improved and more compact apparatus is desired for filtration, compressing, liquid extracting, washing and chemical treating of the sludge, slurries or other wet materials.

### SUMMARY OF THE PRESENT INVENTION

An aspect of the present invention is to provide a system for extracting liquid from a mass comprising a system mass input, a blending system connected to the system mass input, with the blending system being configured to mix a chemical with a fluid to form a mixed solution, a liquid extraction assembly connected to the blending system, and piping having a first section between the system mass input and the blending system and a second section between the blending system and the liquid extraction assembly. The system is configured to have mass inputted into the system mass input, transport the mass to the blending system through the first section of the piping, inject the mixed solution into the mass in the blending system, and transport the mass from the blending system to the liquid extraction assembly. The blending system comprises a mechanically movable assembly for mixing the chemical with the fluid.

Another aspect of the present invention is to provide a method of extracting liquid from a mass comprising inputting the mass into a system mass input, connecting a blending system connected to the system mass input, mixing a chemical and a fluid with the blending system to form a mixed solution, connecting a liquid extraction assembly to the blending system, providing piping having a first section between the system mass input and the blending system and a second section between the blending system and the liquid extraction assembly, transporting the mass to the blending system through the first section of the piping, injecting the mixed solution into the mass in the blending system, transporting the mass from the blending system to the liquid extraction assembly, and extracting the liquid from the mass using the liquid extraction assembly. The blending system comprises a mechanically movable assembly for mixing the chemical with the fluid.

Yet another aspect of the present invention is to provide a chemical and fluid mixing system for use with a system for extracting liquid from a mass comprising a mix housing defining a mixing area, a mix blade within the mixing area, a mix ring surrounding the mix blade, a motor housing having a motor therein, and a seal plate engaged with the mix ring and the motor housing. The mix housing is connected to the motor housing. The motor includes an output shaft extending through a wall of the motor housing and into the mix area, with the output shaft being connected to the mix blade for rotating the mix blade. The housing has an inlet allowing a chemical and a fluid to enter the mixing area along an inlet line and an outlet allowing the chemical and the fluid to exit the mixing area along an outlet line.

These and other aspects, objects, and features of the present invention will be understood and appreciated by those skilled in the art upon studying the following specification, claims, and appended drawings.

### BRIEF DESCRIPTION OF DRAWINGS

FIG. 1 is a top view of a system for extracting liquid from a mass using a polymer blending system of the present invention.

FIG. 2 is a front view of the system for extracting liquid from a mass using a polymer blending system of the present invention.

FIG. 3 is a side view of the system for extracting liquid from a mass using a polymer blending system of the present invention.

FIG. 4 is a schematic of the system for extracting liquid from a mass using a polymer blending system of the present invention.

FIG. 5 is an exploded side view of a first embodiment of the polymer blending system of the present invention.

FIG. 6 is an exploded side view of a second embodiment of the polymer blending system of the present invention.

### DETAILED DESCRIPTION OF PREFERRED EMBODIMENTS

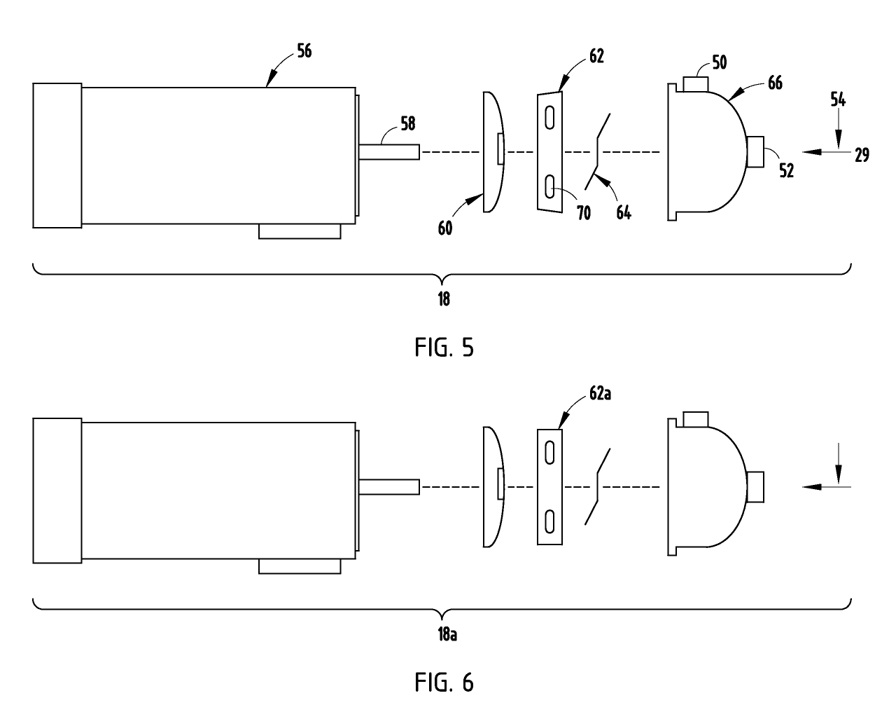

For purposes of description herein, the terms “upper,” “lower,” “right,” “left,” “rear,” “front,” “vertical,” “horizontal,” and derivatives thereof shall relate to the invention as orientated in FIG. 6. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to an apparatus and method for blending two or more liquids into one homogenous liquid stream. For example, the present invention can be used in a polymer blending and surfactant washing system for addition of flocculants and coagulants prior to filtration in liquid/solid extraction systems, thereby enhancing extraction of the liquid from a humid mass (e.g., sludges and slurries), as those used or produced in the pulp and paper industry, waste water treatment plants, pharmaceutical manufacturing, agricultural, food and beverage industries, etc. The present invention is used to assist in removing a portion of liquid from the humid mass.

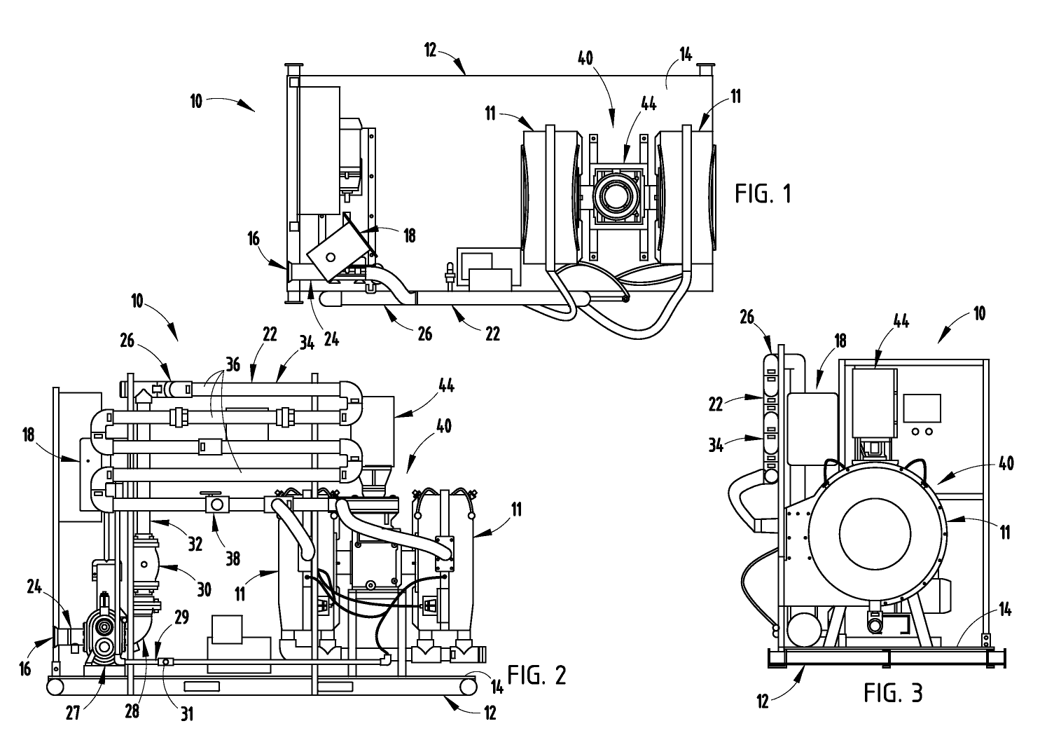

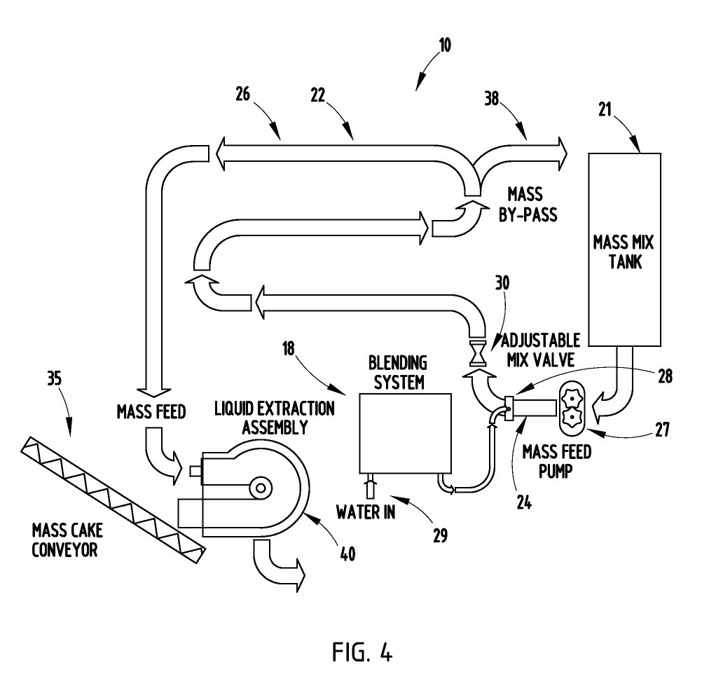

The reference number 10 (FIGS. 1-4) generally designates a system for extracting liquid from a mass using a blending system 18 of the present invention. Such systems 10 for extracting liquid from a mass are well known to those skilled in the art and the system 10 as described herein is only for illustrative purposes. For example, the blending system 10 of the present invention can be used in the system disclosed in PCT Application No. PCT/US2005/028041 entitled ROTARY FAN PRESS, the entire contents of which are hereby incorporated herein by reference.

The illustrated system 10 for extracting liquid from a mass comprises a platform 12 having an upper surface 14, a system mass input 16, the blending system 18 on the upper surface 14, a liquid extraction assembly 40 on the upper surface 14, and piping 22 having a first section 24 between the system mass input 16 and the polymer feeding and blending system 18, and a second section 26 between the polymer feeding and blending system 18 and the liquid extraction assembly 40. The system 10 is configured to have mass inputted into the system mass input 16, transport the mass to the blending system 18 through the first section 24 of the piping 22, inject polymer into the mass in the blending system 18, and transport the mass from the blending system 18 to the liquid extraction assembly 40. Pressure from mass forced into the liquid extraction assembly 40 forces liquid in the mass to exit the mass. In the illustrated embodiment, the liquid extraction assembly 40 comprises a pair of liquid extraction presses 11. However, it is contemplated that the liquid extraction assembly 40 of the present invention could use any number (including only one) of the liquid extraction presses 11 as described in more detail below.

In the illustrated embodiment, the system 10 can either include a source of mass (as shown schematically in FIG. 4) or be configured to be connected to a source of mass (as illustrated in FIG. 1). The mass is preferably a humid mass (e.g., sludges and slurries). As stated above, the mass can be that used or produced in the pulp and paper industry, waste water treatment plants, agricultural industries, food and beverages industries, etc. The system 10 of the present invention removes at least a portion of the liquid in the mass. In the illustrated embodiment, the system 10 is portable and can be directly brought to the pulp and paper industry, waste water treatment plants, agricultural industry, food and beverages industries, etc. for use at those locations. The system mass input 16 is configured to be connected to a hose that transports the mass to the system 10 from the source of mass. Preferably, the system 10 is located on the platform 12 that has an upper surface 14 smaller than 72 square feet to provide a compact and easily movable system. However, several of the inventive features disclosed herein can be used in a stationary and fixed system. In a stationary and fixed system, the source of mass can comprise a tank 21 (see FIG. 4) having the mass therein, with the tank 21 communicating with the system mass input 16.

The illustrated system 10 preferably includes a mass feed pump 27 for assisting in drawing the mass from the source of mass through the hose or from the tank 21. The mass feed pump 27 also provides pressure to the mass to assist in moving the mass through the piping 22 and into and through the liquid extraction assembly 40. Mass feed pumps 27 are well known to those skilled in the art. After passing through the mass feed pump 27, the mass is fed into the blending system 18. The blending system 18 is configured to be connected to a water supply 29 for mixing water with polymer in the blending system 18. In the illustrated example, the system 10 includes a fitting 31 for connecting to a water supply for supplying the blending system 18 with the water. The blending system 18 includes an injection area 28 connected to the first section 24 and the second section 26 of the piping 22 and defines a transition from the first section 24 to the second section 26. After the water is mixed with the polymer, a combination of the water and polymer is injected into the injection area 28 for mixing with the mass from the first section 24 before the mass is moved to the second section 26 of the piping 22. The blending system 18, as discussed in more detail below, preferably uses a polymer that is preferably a conventional known polymer flocculent, such as a polyacrylamide.

In the illustrated example, once the mass is moved to the second section 26 of the piping 22, the mass is thoroughly mixed with the combination of polymer and water in an adjustable mix valve 30 in the second section 26 of the piping 22. The second section 26 of piping 22 preferably includes a first portion 32 extending vertically upwards from the mix valve 30 to a top of the second section 26 of the piping 22. The second section 26 of the piping 22 also includes a second portion 34 comprising a plurality of horizontal rows 36 of pipes, with each row 36 connected at one end to the row 36 above and at another end at the row 36 below. The second portion 34 of the second section 26 of the piping 22 is connected to the liquid extraction assembly 40, wherein the mass is fed into the liquid extraction assembly 40. In the illustrated embodiment, the second section 26 of the piping 22 includes a mass bypass tube 38 having a selectively opening valve for allowing the mass in the second section 26 of the piping 22 to bypass the liquid extraction assembly 40. It is contemplated that the mass taken out of the second section 26 of the piping 22 could be reinserted into the system 10 by placing the mass taken out of the second section 26 into the source of mass or directly or indirectly into the system mass input 16. Likewise, the second section 26 of the piping 22 can include an extraction valve for each liquid extraction press 11 of the liquid extraction assembly 40 for selectively allowing the mass in the second section 26 to be fed into one or more of the liquid extraction presses 11. FIG. 4 illustrates a schematic representation of the system 10. As shown schematically in FIG. 4, the system 10 can include at least one conveyor 35 for accepting the solid portion of the mass exiting one or more of the liquid extraction assemblies 40 to move the mass to a disposal or collecting device (not shown).

In the illustrated example, the liquid extraction assembly 40 accepts the mass from the piping 22 and outputs a solid and the at least a portion of the liquid. The liquid extraction assembly 40 of the present invention includes a pair of liquid extraction presses 11 connected to a motor assembly 44. In the illustrated example, the system 10 of the present invention comprises a pair of liquid extraction presses 11 that share the motor assembly 44. However, it is contemplated that only one liquid extraction press 11 could be used or that each liquid extraction press 11 could have its own motor assembly 44. Furthermore, the system 10 can include any number of liquid extraction presses 11.

The blending system 18 of the present invention is configured to be connected to the water supply 29 for mixing water with a chemical (e.g., polymer) in the blending system 18. The blending system 18 includes an outlet 50 configured to be connected to the piping of the liquid extraction system. The chemical is preferably a polymer, and is more preferably a conventional known polymer flocculent, such as a polyacrylamide. The polymer and water mixture flocculates the mass to assist in removing the liquid from the mass.

In the illustrated example, the blending system 18 includes an inlet 52 for accepting the water from the water supply 29 and the chemical from a chemical supply 54. Although the water and the chemical are shown as coming into the blending system 18 together, it is contemplated that the chemical and the water can be separately introduced into the blending system 18. Furthermore, it is contemplated that the chemical can originate as an emulsion (liquid) or dry powder in the present invention. Preferably, the chemical from the chemical supply is an emulsion. The emulsion is in a concentrated form with different viscosities, etc. and percent active (typically 30-40% active) product. However, it is contemplated that a dry powder could be used, with the powder blended to end with an emulsion equivalent. The blending system 18 of the present invention also includes the outlet 50 for outputting the homogenously mixed water and chemical.

The illustrated blending system 18 includes a drive motor 56 with a motor housing 59 having an output shaft 58, a back seal plate 60, a tapered mix ring 62, a mixer blade 64 and a mix housing 66 having the inlet 52 and the outlet 50. The back seal plate 60 includes a centrally located opening for accepting the output shaft 58 of the drive motor 56 therethrough. Preferably, the back seal plate 60 is affixed to the motor housing 59. The tapered mix ring 62 is connected to the mix housing 66, and/or the back seal plate 60, preferably by screws, bolts or other type of fasteners (although other connection means could be used (e.g., welding)). The mixer blade 64 is connected to the output shaft 58 of the drive motor 56 and rotates therewith. The mixer blade 64 comprises two fixed, tapered blade portions from a center of the mixer blade 64 (i.e., the portion connected to the output shaft 58). The angle of the blade portions and an edge blade taper of the blade portions causes a back and forth motion within the mixing area. The mix housing 66 is sealed to the back seal plate 60 thereby defining a mixing area between an inside of the mix housing 66 and the back seal plate 60.

In use, the water and the chemical enter the mixing area of the blending system 18 through the inlet 52. The water and the chemical are then thoroughly mixed using the mixer blade 64. The tapered mix ring 62 also assists in mixing as the mixture will abut against an inside of the tapered mix ring 62 to flow the mixture back towards the mixer blade 64 to further mix the mixture and to preferably wash the surfactants from the chemical chains (e.g., polymer chemical chains). The tapered mix ring 62 also includes a plurality of oval shaped discharge openings 70, with the mixture preferably exiting through the openings 70 before the mixture exits the mix housing 66 through the outlet 50. Preferably, the emulsion polymer is diluted in the water at an ending dilution of about 0.5-0.2% polymer in the mixture. In order to get the most activation out of the polymer, the water has to come in contact with the active polymer. In order to do this, the water has to wash away the surfactants first and then blend into the active polymer, which will then uncoil (expand). Thereafter, the mixture is injected into the sludge/slurry to flocculate the solids. The blending system 18 of the present invention uses approximately 50-70% less polymer than prior art mixers and also helps achieve a better dewatered cake (solids) after the sludge goes through the liquid extraction system.

The reference numeral 18a (FIG. 6) generally designates another embodiment of the present invention, having a second embodiment for the blending system. Since blending system 18a is similar to the previously described blending system 18, similar parts appearing in FIG. 5 and FIG. 6, respectively, are represented by the same, corresponding reference number, except for the suffix “a” in the numerals of the latter. The second embodiment of the blending system 18a is identical to the first embodiment of the blending system 18, except that the mix ring 62a is not tapered.

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A system for extracting liquid from a mass comprising:
a system mass input;
a blending system connected to the system mass input, the blending system being configured to mix a chemical with a fluid to form a mixed solution;
a liquid extraction assembly connected to the blending system; and
piping having a first section between the system mass input and the blending system, and a second section between the blending system and the liquid extraction assembly;
wherein the system is configured to have mass inputted into the system mass input, transport the mass to the blending system through the first section of the piping, inject the mixed solution into the mass in the blending system, and transport the mass from the blending system to the liquid extraction assembly; and
wherein the blending system comprises a mechanically movable assembly for mixing the chemical with the fluid.

2. The system for extracting liquid from a mass of claim 1, wherein:
the mechanically movable assembly comprises a mixing blade within a mixing area and a motor for rotating the mixing blade.

3. The system for extracting liquid from a mass of claim 2, wherein:
the mixing blade comprises two oppositely angled tapered blade portions extending from a center blade portion, with an angle of the oppositely angled tapered blade portions causing a back and forth motion of the chemical and the fluid within the mixing area.

4. The system for extracting liquid from a mass of claim 2, wherein:
the blending system comprises a housing defining the mixing area, the housing having an inlet allowing the chemical and the fluid to enter the mixing area along an inlet line and an outlet allowing the chemical and the fluid to exit the mixing area along an outlet line.

5. The system for extracting liquid from a mass of claim 4, wherein:
the outlet line and the inlet line are perpendicular.

6. The system for extracting liquid from a mass of claim 2, wherein:
the blending system comprises a mix housing defining the mixing area and includes a mix ring surrounding the mixing blade within the mixing area, the mix ring having a circular portion and a plurality of openings in the circular portion.

7. The system for extracting liquid from a mass of claim 6, wherein:
the openings are oval.

8. The system for extracting liquid from a mass of claim 6, wherein:
the circular portion of the mix ring is tapered to define a frusto-conical body.

9. The system for extracting liquid from a mass of claim 6, wherein:
the blending system further includes a motor housing having the motor therein, with the mix housing being connected to the motor housing;
the motor includes an output shaft extending through a wall of the motor housing and into the mix area, with the output shaft being connected to the mix blade for rotating the mix blade.

10. The system for extracting liquid from a mass of claim 9, wherein:
the blending system further includes a seal plate engaged with the mix ring and the motor housing.

11. A method of extracting liquid from a mass comprising:
inputting the mass into a system mass input;
connecting a blending system connected to the system mass input;
mixing a chemical and a fluid with the blending system to form a mixed solution;
connecting a liquid extraction assembly to the blending system;
providing piping having a first section between the system mass input and the blending system, and a second section between the blending system and the liquid extraction assembly;
transporting the mass to the blending system through the first section of the piping;
injecting the mixed solution into the mass in the blending system;
transporting the mass from the blending system to the liquid extraction assembly; and
extracting the liquid from the mass using the liquid extraction assembly;
wherein the blending system comprises a mechanically movable assembly for mixing the chemical with the fluid.

12. The method of extracting liquid from a mass of claim 11, wherein:
the mechanically movable assembly comprises a mixing blade within a mixing area and a motor for rotating the mixing blade.

13. The method of extracting liquid from a mass of claim 12, wherein:
the mixing blade comprises two oppositely angled tapered blade portions extending from a center blade portion, with an angle of the oppositely angled tapered blade portions causing a back and forth motion of the chemical and the fluid within the mixing area.

14. The method of extracting liquid from a mass of claim 12, wherein:
the blending system comprises a housing defining the mixing area, the housing having an inlet allowing the chemical and the fluid to enter the mixing area along an inlet line and an outlet allowing the chemical and the fluid to exit the mixing area along an outlet line.

15. The method of extracting liquid from a mass of claim 14, wherein:
the outlet line and the inlet line are perpendicular.

16. The method of extracting liquid from a mass of claim 12, wherein:
the blending system comprises a mix housing defining the mixing area and includes a mix ring surrounding the mixing blade within the mixing area, the mix ring having a circular portion and a plurality of openings in the circular portion.

17. The method of extracting liquid from a mass of claim 16, wherein:
the openings are oval.

18. The method of extracting liquid from a mass of claim 16, wherein:
the circular portion of the mix ring is tapered to define a frusto-conical body.

19. The method of extracting liquid from a mass of claim 16, wherein:
the blending system further includes a motor housing having the motor therein, with the mix housing being connected to the motor housing;
the motor includes an output shaft extending through a wall of the motor housing and into the mix area, with the output shaft being connected to the mix blade for rotating the mix blade.

20. The method of extracting liquid from a mass of claim 19, wherein:
the blending system further includes a seal plate engaged with the mix ring and the motor housing.

21. A chemical and fluid mixing system for use with a system for extracting liquid from a mass comprising:
a mix housing defining a mixing area;
a mix blade within the mixing area;
a mix ring surrounding the mix blade;
a motor housing having a motor therein, with the mix housing being connected to the motor housing, the motor including an output shaft extending through a wall of the motor housing and into the mix area, with the output shaft being connected to the mix blade for rotating the mix blade; and
a seal plate engaged with the mix ring and the motor housing;
the housing having an inlet allowing a chemical and a fluid to enter the mixing area along an inlet line and an outlet allowing the chemical and the fluid to exit the mixing area along an outlet line.

22. The chemical and fluid mixing system of claim 21, wherein:
the outlet line and the inlet line are perpendicular.

23. The chemical and fluid mixing system of claim 21, wherein:
the mix ring has a circular portion and a plurality of openings in the circular portion.

24. The chemical and fluid mixing system of claim 23, wherein:
the openings are oval.

25. The chemical and fluid mixing system of claim 23, wherein:
the circular portion of the mix ring is tapered to define a frusto-conical body.

26. The chemical and fluid mixing system of claim 21, wherein:
the mixing blade comprises two oppositely angled tapered blade portions extending from a center blade portion, with a angle of the oppositely angled tapered blade portions causing a back and forth motion of the chemical and the fluid within the mixing area.
